(19) United States
(12) Patent Application Publication
(10) Pub. No.: US 2024/0340215 A1
(43) Pub. Date: Oct. 10, 2024

(54) DISCOVERING AND RETRIEVING MANAGEMENT DATA IN A TELECOMMUNICATIONS NETWORK

(71) Applicant: Microsoft Technology Licensing, LLC, Redmond, WA (US)

(72) Inventors: Michael Anthony BROWN, McKinney, TX (US); Bahareh SADEGHI, Vancouver, WA (US)

(21) Appl. No.: 18/328,587

(22) Filed: Jun. 2, 2023

Related U.S. Application Data
(60) Provisional application No. 63/495,003, filed on Apr. 7, 2023.
(60) Provisional application No. 63/503,115, filed on May 18, 2023.

(51) Int. Cl. H04L 41/02

(52) U.S. Cl. CPC H04L 41/024

(57) ABSTRACT

The present disclosure relates to discovering and retrieving stored management data associated with operation of components (e.g., network functions) on a telecommunications network environment (e.g., a 3^{rd} Generation Partnership Project (3GPP) environment). In particular, the present disclosure relates to implementations that enable consumer entities to discover the location(s) of management data and a variety of approaches related to retrieving the management data at the respective locations. Examples include direct self-discovery, indirect self-discovery, and proxy-driven discovery and recovery techniques. The systems described herein manage access to the stored management data for any number of consumer entities that request access to any of a variety of types of management data. The systems described herein are implemented on a core network and provide functionality related to storing and accessing management data in a cellular network (e.g., a fifth generation (5G) telecommunications network).

### CROSS-REFERENCE TO RELATED APPLICATIONS

This application is related to and claims priority to U.S. Provisional Patent Application No. 63/495,003, filed on Apr. 7, 2023. This application is also related to and claims priority to U.S. Provisional Patent Application No. 63/503,115, filed on May 18, 2023. The entirety of each of these applications are hereby incorporated by reference.

### BACKGROUND

A cloud computing system refers to a collection of computing devices capable of providing remote services and resources. Indeed, cloud computing systems can provide a variety of services including storage, databases, networking, software, and analytics services. The use of cloud computing technology has grown rapidly in recent years. This is due at least in part to the development of high-capacity networks as well as reduced costs for computers and storage devices.

Broadly speaking, a cloud computing system includes two sections, a front end and a back end, which are in communication with one another via the internet. The front end includes the interface that users encounter through a client device. The back end includes the resources that deliver cloud-computing services, including processors, memory, storage, and networking hardware. These resources are connected by one or more communication networks. Advantageously, the group of networked elements providing services does not have to be individually addressed or managed by users. Instead, the entire provider-managed suite of hardware and software can be thought of as a “cloud.”

The back end of a cloud computing system typically includes one or more datacenters. A datacenter is a physical facility that is used to house computing systems and associated components. A datacenter typically includes a large number of computing systems (e.g., servers), which can be stacked in racks that are placed in rows. An entity that owns and/or operates a cloud computing system can be referred to as a cloud computing provider. A cloud computing provider can have a plurality of datacenters, and these datacenters can be located in different geographical areas.

A “private cloud” is cloud infrastructure operated solely for a single organization, whether managed internally or by a third party, and hosted either internally or externally. A cloud is called a “public cloud” when the services are rendered over a network that is open for public use. Generally, public cloud service providers own and operate the cloud infrastructure at their datacenters and access to users generally occurs via the Internet. A “hybrid cloud” architecture is the combination of public and private clouds by a wide area network or broadband connection.

There are many different types of services that cloud computing providers can offer to customers. One type of cloud computing service is referred to as Infrastructure as a Service (IaaS). IaaS is a form of cloud computing that delivers compute, network, and storage resources to consumers on-demand, over the Internet. IaaS enables end users to scale and shrink resources on an as-needed basis, reducing the need for large, up-front capital expenditures. This can be particularly beneficial for users who anticipate having variable workloads.

The subject matter in the background section is intended to provide an overview of the overall context for the subject matter disclosed herein. The subject matter discussed in the background section should not be assumed to be prior art merely as a result of its mention in the background section. Similarly, a problem mentioned in the background section or associated with the subject matter of the background section should not be assumed to have been previously recognized in the prior art.

### BRIEF DESCRIPTION OF THE DRAWINGS

FIG. 1 illustrates an example environment showing systems and devices implemented in a telecommunications network, in accordance with at least one or more embodiments.

FIG. 2 is a diagram illustrating an example implementation of a consumer self-discovering management data in telecommunication network, in accordance with at least one or more embodiments.

FIG. 3 is a diagram illustrating an example implementation of a consumer self-discovering management data in telecommunication network having multiple data storages, in accordance with at least one or more embodiments.

FIG. 4 illustrates an example environment showing systems and devices that may be implemented in a telecommunications network.

FIG. 5 is a signaling diagram illustrating an example of a proxied-discovery of management data in telecommunication network, in accordance with at least one or more embodiments.

FIG. 6 illustrates a series of acts for coordinating retrieving and coordinating access to management data stored in a core network of a telecommunications environment, in accordance with at least one or more embodiments.

FIG. 7 illustrates a series of acts for retrieving and coordinating access to management data stored in a 5G telecommunication network, in accordance with at least one or more embodiments.

FIG. 8 illustrates certain components that may be included within a computer system.

### DETAILED DESCRIPTION

The present disclosure relates generally to systems, methods, and computer-readable media for discovering and recovering management data associated with operation of components (e.g., network functions) on a telecommunications network environment (e.g., a 3^{rd} Generation Partnership Project (3GPP) environment). The systems herein involve an architecture and framework related to discovering and retrieving management data associated with operation of components on a telecommunications network.

The systems described herein relate to a plurality of implementations that involve an authorized consumer (or simply “consumer”) obtaining access to management data in a variety of ways. In one or more embodiments described herein, the systems described herein are implemented on a core network and provide features and functionality related to discovering and retrieving management data in a fifth generation (5G) telecommunications network as well as future generations of telecommunications networks.

Mobile networks have the capability to support a wide variety of services. This ability to support a variety of services, along with increasing flexibility in hosting network resources presents management and operational challenges. In addition, with movement of 5G and future generations of telecommunications networks towards automation and observability, there is a greater need for management data to be discoverable and consumed by various entities in the network. Indeed, a greater number of consumers are requesting access to management data than ever before.

Conventionally, management data is collected from various sources in a telecommunications network based on requests from network entities that are consumers of the data that is delivered to them. The management data is also typically stored for future access. This stored management data (also referred to as historical data) can be used for a variety of purposes (e.g., machine learning model training, analysis of network behaviors, etc.).

In multi-vendor environments, different entities of the telecommunications network may be associated with different vendors. For example, a management data producer (e.g., network functions), storage services (e.g., data bus solutions and data storages), and management data consumers (e.g., operations and maintenance solutions of network operators) may be implemented by different vendors. In these multi-vendor environments, it can be difficult for consumers to discover and retrieve management data, particularly in the absence of interoperable and standardized solutions for discovering and retrieving stored management data. In one or more embodiments described herein, systems are disclosed that provide this interoperable and standardized solution that enables consumer entities to discover and retrieve stored management data of a variety of types and from a variety of sources.

To illustrate the need to access stored management data (historical data) and to overcome the above-difficulties, a 3GPP SA5 group on Study on Data Management has articulated the following: “Storing management data enables reusage of management data for multiple management purposes. For example, AI/ML models need input data collected over a certain period of time for training purposes. A specific set of collected data may serve different purposes and can therefore be input to multiple AI/ML services. For example, management data collected in a geographical area may be used also for another geographical area when the scenarios in the areas are statistically similar. Another use case for storing produced data is related to the fact that multiple sets of training data from similar scenarios are typically required. For example, one set of data produced for the rush hour in a subway station on a single weekday is typically not enough for profiling. Many sets produced on many workdays are required. Stored data is useful when management functions can discover which data has been produced and stored in the past to check if the currently needed data is already available.”

Conventionally, facilitating discovery and recovery of stored network data involves a specific network function (e.g., an analytics data repository function (ADRF), which can be used to store network analytics and analytics thereon. Management data is distinguishable from network data generally where network data refers more specifically to activity of one or more network functions, including the status of operation and functionality the network functions provide.

In 3GPP working group SA5, however, there currently does not exist a framework for coordinating, providing, and otherwise managing access to stored management data associated with operation of components of the telecommunications network. For example, telecommunications networks currently do not provide a standardized mechanism to coordinate requests to access stored management data such as fault supervision data, trace data, performance management data, configuration management data, and other types of management.

The features and functionalities described herein provide a number of advantages and benefits over conventional approaches and systems. For example, the systems described herein provide features and functionality related to coordinating management and access to management data for efficient and optimal transportation of data between entities of the telecommunications network. Indeed, the systems described herein provide an architecture including data coordination functionality which ensures efficient discovery and retrieval of stored management data and in a manner that enables retrieval of the stored management data by consumers in communication with (and/or implemented within) the telecommunications network.

In addition to providing efficient transportation of data, the systems described herein include features related to managing centralized entity storing information about stored management data as well as a unique identifier of the management data service provider server that stores it. By having a centralized entity storing information about multiple different storage server contents any consumer with any management data requirements is able to easily find a management data service provider device that stores the particular management data the consumer needs. This can be advantageous in systems where there are multiple management data service provider devices and contacting each of them separately to query about particular management data may be an inefficient use of resources.

Moreover, one or more embodiments described herein provide a centralized system and method for accessing both real-time management data and stored management data without the need for the consumer to identify beforehand if the management data they require is one or the other. Indeed, a centralized entity configured to manage management data requests and to collect, store, and deliver management data based on various different requests from various different consumers simplifies the management and delivery of management data as consumers interact with the centralized entity.

The above-benefits may be accomplished across a variety of frameworks including frameworks in which the management data is highly distributed (e.g., distributed across a large number of storage instances) or where a relatively few number of storage instances are maintained in the telecommunications network. Indeed, as will be discussed below, the systems described herein may make use of one or a combination of discovery and recovery frameworks including, by way of example, a self-driven recovery of management data, a self-driven discovery and recovery of management data, and a proxy-driven discovery and recovery of management data. Each of these approaches may be within new or existing frameworks of mobile communication environments, thus providing flexibility in how the management data is discovered and/or retrieved by various consumer entities.

As illustrated in the foregoing discussion, the present disclosure utilizes a variety of terms to describe features and advantages of the systems herein. Additional detail is now provided regarding the meaning of some example terms.

As used herein, “network management data” or simply “management data” refers to data that is obtained from a variety of sources on a telecommunications network and which is used in management and orchestration of the telecommunications network. In one or more embodiments, management data refers to data that is collected to manage operation of the framework as well as optimize management of network resources. Examples of management data include, but are not limited to, performance measurement data (e.g., faults, alarms), trace information, key performance indicators, radio access network (RAN) data, and external management data (e.g., any data that is not specified by 3GPP and can be used for management of the network). Management data is distinguishable from network data generally where network data refers more specifically to activity of one or more network functions, including the status of operation and functionality the network functions provide. In one or more embodiments, management data refers to how the data is used, such as in management and orchestration of the telecommunications network (as noted above). As discussed herein, management data may originate from a plurality of different sources. In one or more embodiments, management data is specified by 3GPP specifications. For example, in one or more implementations, management data specified by 3GPP for 5G management is classified into 5G performance measurements as defined by TS 28.552, 5G end to end key performance indicators as defined by TS 28.554, and trace/MDT data as defined by TS 32.422.

In one or more embodiments, management data refers to one of internal management data or external management data. As used herein, internal management data refers to any data defined as management data in a corresponding technical specification (e.g., 3GPP specification) defining standards and functionality provided by the telecommunications network. In one or more embodiments described herein, the management data refers to data defined as management data by 3GPP technical specification 28.532. Nevertheless, management data as defined by other technical specifications may similarly be used in characterizing data as internal management data. Conversely, as used herein, external management data refers to data that is used for management and operation of the telecommunications network that is not explicitly specified by 3GPP. For example, external management data may be produced by data sources of a different nature (e.g., sensors) with different formats. In one or more embodiments, the internal management data may be enriched by external data to provide additional input for network optimization and prediction. Both the internal management data and the external management data may be stored on a data storage and provided to consumers by a management data service provider.

As used herein, “a network element” is a manageable logical entity uniting one or more physical devices. For example, a network element may be a static network element or a dynamic network element. A static network element is configured with a fixed set of parameters that do not change unless manually reconfigured. Whereas dynamic network element is a device that can be automatically reconfigured.

As used herein, “service registry” or simply “registry” refers to a network element that stores information (e.g., records or registers) about various different services provided by other network elements. For example, a service registry may act as a point of contact for a consumer who is trying to find a service provider.

A “consumer entity” or “consumer” or “management service consumer” (MnS consumer) may refer to any authorized consumer that is allowed to request and obtain access to some portion of management data managed by the systems described herein. For example, a consumer may refer to a network function that requests access to management data. As an illustrative example, a consumer may refer to a management data analytics function (MDAF) that uses data collected by another network element or data that is stored in a data storage system. The consumer may be a network function on a 5G telecommunication network, or on a cloud computing system hosting a 5G telecommunication network. Another example of a consumer may be a network data analytics function (NWDAF). A further example of a consumer may be a network function that hosts an AI/ML models (or simply “machine learning models,” as used in various examples herein) that collect data over a period of time for training and/or AI implementation purposes. In one or more embodiment, a consumer may refer to an entity implemented on an edge network. A consumer may refer to a remote consumer, such as a consumer entity implemented on a datacenter of the cloud computing system. A consumer may refer to a network function on a core network of the telecommunications network. Indeed, a consumer may refer to any entity that requests access to management data. Additional examples of consumers will be discussed in connection with examples provided below. In one or more embodiments, a management data may be consumed by an entity, which may in turn produce the management data to other entities. As a non-limiting example, management data may be initially produced by a network function, provided to and/or consumed by a network management function, and further provided to a third entity for further processing (e.g., an analytics function or service). In this example, the first entity (e.g., the network function) may first produce unprocessed management data that the network management function consumes. The network management function may then create a report using said unprocessed management data and produce it to a third entity, such as an analytics service. In the above sample, the network management function first acts as a consumer for the management data produced by the network function, and as a management data producer for the third entity, the third entity being a consumer for the management data produced by the network management function.

In one or more embodiments described herein, a telecommunication network environment may refer to a standardized telecommunication network. The telecommunication network environment may include a radio access network, core network, cloud infrastructure, and any other regions of collections of components that enable consumers to utilize various services of a cloud infrastructure. One or more embodiments described herein refer specifically to a 4G, 5G and beyond or other 3GPP communication environment. Nevertheless, features described herein in connection with consumer entities, cloud native management entities, and cloud infrastructure management systems may be applicable across a wide variety of communication environments and are not necessarily limited to the specific 5G or other 3GPP standard environments discussed in connection with specific examples herein.

As used herein, a “management data producer” or a “Management Service Producer” (MnS Producer) is a network entity capable of producing management data. Management data may be produced by any entity. For example, management data may be produced by a Network Function(s) (NF), such as radio network function(s) and/or core network function(s). In another example, management data may be produced by a network management function(s). The management data producer may produce, for example, performance management data, configuration management data, and fault supervision data.

Consistent with one or more examples discussed above, the management data may refer to raw or unprocessed management data as received from a data producer (e.g., unprocessed management data as it is received from the producer). Alternatively, in one or more embodiments, management data refers to processed management data (e.g., data obtained based on calculations or processing performed on the management data as collected from the producer(s)). Processed management data may include machine learning model(s) based on the unprocessed management data, report(s) created using the unprocessed management data, or analytic data performed on the unprocessed management data.

Additional detail will now be discussed in connection with example figures and different example implementations of systems that facilitate efficient and effective discovery of management data that may be used in a variety of networking environments and scenarios. Each of the examples described herein may be used independently or in combination with one another and may be used in different deployment scenarios.

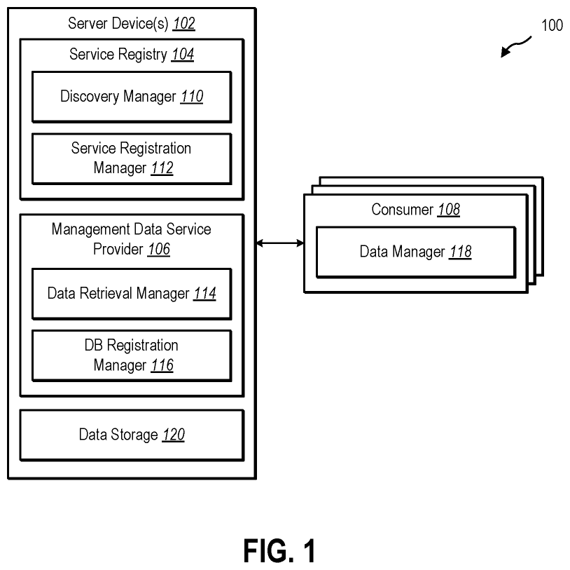

FIG. 1 illustrates an example environment 100 showing systems, devices, functions, and other entities that may be implemented in a telecommunications network. As shown in FIG. 1, the environment 100 includes one or more server devices 102 (e.g., producer devices) and consumers 108 in communication with one another. In the example shown in FIG. 1, the environment 100 includes a service registry 104, management data service provider 106, and data storage 120 implemented on a server device(s) 102. In one or more embodiments, two or more of the service registry 104, management data service provider 106, and data storage 120 may be stored on a same server device 102. In one or more embodiments, the service registry 104, management data service provider 106, and data storage 120 may be stored on two or more separate server devices 102. In one or more embodiments, one or more of the service registry 104, management data service provider 106, and data storage 120 may be implemented within core network and/or cloud computing system.

In one or more embodiments, the service registry 104 may be a “MnS Registry” (See e.g., TS 28.622 clause 4.3.41). In one or more embodiments, the service registry 104 is a unique entity in an operator network (e.g., a public land and mobile network (PLMN)) where an address is configured at all devices.

As further shown, the service registry 104 optionally includes a service registration manager 112 implemented thereon. The service registration manager 112 may receive service registration requests from the management data service provider 106 (or other entities, such as a data producer). The registration request may include a unique identifier (e.g., an address) for the management data service provider 106. For example, the address may be represented as an IP address that identifies the server device 102 containing the management data service provider 106 on a network. The service registration manager 112 may then register the management data service provider 106 as a service provider in its registry. For example, the service registration manager 112 may register the particular management data service provider 106 as providing stored management data to authorized consumers.

In one or more embodiments, the service registration manager 112 contains a list of registered service providers with their unique identifier (e.g., address). In one or more embodiments, this list may include information about a type of management data stored. For example, the management data type may be a performance data, faults data, traces data, or any other management data type. In one or more embodiments, the list may further include a specified collection window during which the management data was collected. For example, the list may identify that the management data was collected between May 1st and May 2nd of 2023, or between 6 AM and 7 AM (GMT) of May 1st, 2023.

In one or more embodiments, the list may further include information about a format in which the management data is stored. For example, the format type may be text format, numeric format, file format, block format, object format, or other format type.

In one or more embodiments, the list may further include a data producer type. For example, the data producer type could be a core network function, radio network function, or a network management function. In one or more embodiments, the list may further include an instance on which the data was produced. For example, the data many be produced by a first Access and Mobility Management Function (AMF) (AMF #1) or a second AMF (e.g., AMF #2). In one or more embodiments, the list may further include a geographical location in which the data was produced. For example, if the information was collected from Seattle, WA, or from New York, NY.

As shown in FIG. 1, the service registry 104 may further include a discovery manager 110 implemented thereon. The discovery manager 110 may be configured to receive requests from consumers 108 and to respond to the requests. For example, the request may be a request for finding a management data service provider who provides management data (e.g., a management data service provider 106). The discovery manager 110 may be further configured to search information on the service registry 104 for a match based on the request. For example, the request may identify that the consumers 108 is searching for stored management data from a particular management data producer (e.g., a RAN function), or the request may identify other specific requirements for the management data as further discussed below. In one or more embodiments, a response may include, by way of example, a unique identifier of a management data service provider 106 (e.g., an IP address).

The management data service provider 106 may be implemented as a single entity or it may be implemented as a distributed system that includes multiple entities with multiple different unique identifiers (e.g., IP addresses). It will be noted that one or more implementations may include multiple management data service provider 106 entities.

As shown in FIG. 1, the management data service provider 106 optionally includes a database (DB) registration manager 116 implemented thereon. The DB registration manager 116 may send out a registration request to the service registry 104 in order to provide services to the consumers 108. For example, the DB registration manager 116 may provide to the service registry 104 a unique identifier of the management data service provider 106 so that the consumers 108 may request services from the management data service provider 106. In one or more embodiments, the DB registration manager 116 may also provide to the service registry 104 information about the services it provides. For example, the DB registration manager 116 may indicate in its registration request that it may provide management data to authorized consumers 108.

As further shown in FIG. 1, management data service provider 106 may optionally include a retrieval manager 114. The retrieval manager 114 may receive service requests from consumers 108 that identify the type of service the consumers 108 needs. For example, a consumer 108 may request management data. The retrieval manager 114 may then locate and deliver the requested data to consumers 108 in response to the request. In one or more embodiments, if the requested management data is not found by the management data service provider 106, or the data retrieval manager 114 is otherwise unable to locate the requested management data, the retrieval manager 114 may respond with data not found message or with unexpected failure message.

As shown in FIG. 1, the management data service provider may retrieve the requested management data from one or more data storage(s) 120. In one or more embodiments, the data storage 120 may be connected to a data producer, such as the network element producing the management data. In one or more embodiments, the data storage 120 may be located with the data producer on a same server device. In one or more embodiments, the management data service provider 106 may include the data storage 120. In one or more embodiments, the management data service provider 106 may refer to the data producer that maintains and provides access to the data storage 120.

As shown in FIG. 1, the environment 100 includes any number of consumer entities (e.g., consumers 108). As discussed above, the consumers 108 may refer to any entity requesting access to the stored management data collected from the various sources and maintained on one or more data storage 120. In one or more embodiments described herein, the consumers 108 refer to network functions on a cloud computing system (e.g., a core network deployed on the cloud computing system) requesting access the stored management data. For example, a consumer 108 may be a management data analytics function (MDAF) that provides management data analytics services for one or more network functions, network slice subnet instances, and/or network slice instances. In this example, the consumer (e.g., the MDAF) may run different analytics on the stored management data as defined in 3GPP TS 28.533. In another example, a consumer may refer to a network data analytics function (NWDAF) that runs analytics on stored management data as defined in 3GPP TS 23.288.

The consumer(s) 108 in search of specific management data may inquire the service registry 104 regarding availability of the desired management data. In return, the consumer(s) 108 may learn whether the management data is stored and, if so, which management data service provider 106 provides access to the management data along with their unique identifiers. In one or more embodiments, the desired management data may be provided by one or more management data service provider(s) 106. In one or more embodiments, one or more management data service provider(s) 106 may have access to one or more data storage(s) 120.

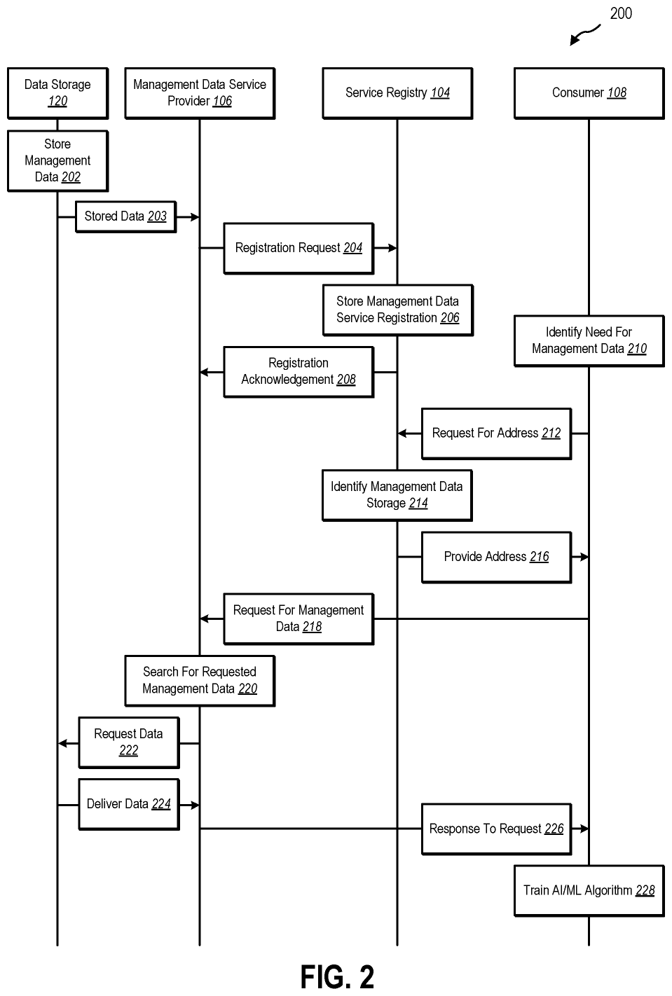

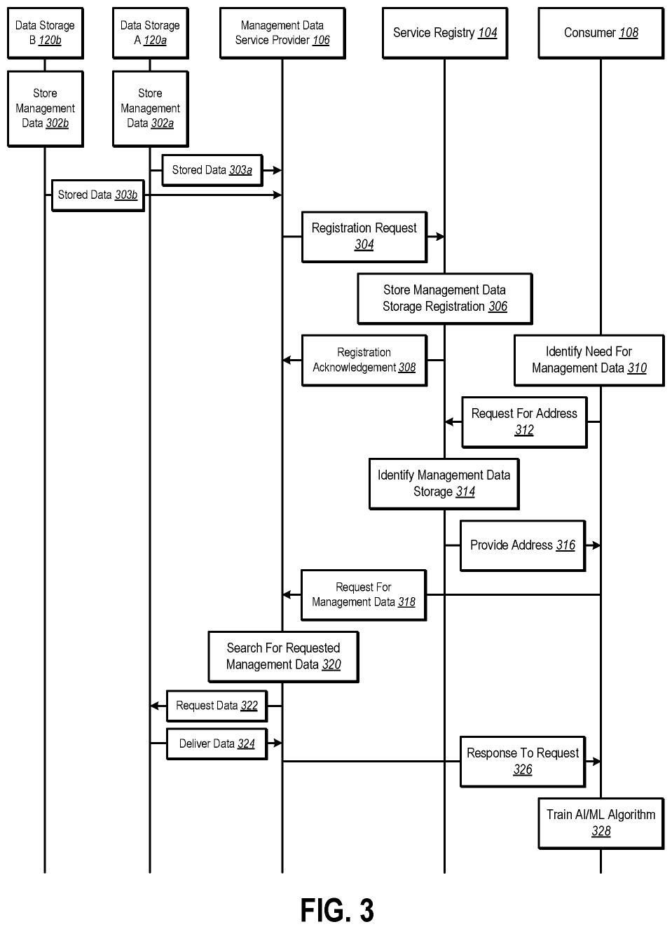

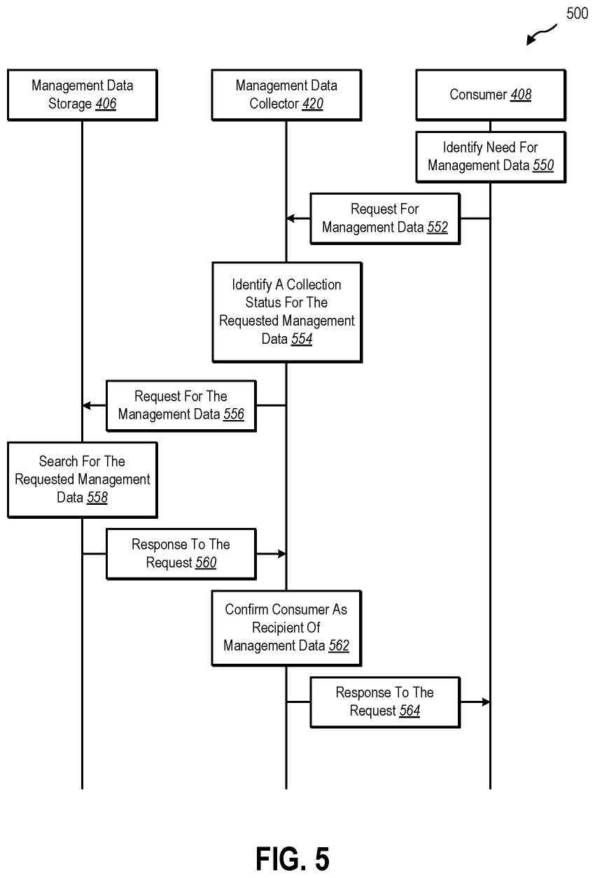

Additional details will now be discussed in connection with a number of proposed solutions. For example, in one or more embodiments, the systems described herein facilitate self-discovery of management data by one or more consumers of the management data itself. Indeed, the example provided in FIG. 2 aims at discovering management data for the consumer's own purpose, while the example provided in FIG. 3 aims at discovering a specific management data. In one or more embodiments, the systems described herein facilitate proxied-discovery of management data by one or more proxy. Indeed, the example provided in FIG. 5 aims at providing proxied-discovery of management data.

FIG. 2 is a diagram 200 illustrating an example implementation of a consumer self-discovering management data in telecommunication network, in accordance with at least one or more embodiments. A shown in FIG. 2, the data storage 120 may perform an act 202 of storing a management data. For example, the management data may be written to the data storage's 120 storage media, such as hard drive, solid-state drive (SSD), USB flash drives, or optical discs. In one or more embodiments, the management data may have been produced by a management data producer. For example, a management data producer may be one or more of a core network function, a radio network function, or a network management function. In one or more embodiments, the management data may be received by the data storage 120 from the management data producer, or from another data storage 120. For example, a primary data storage 120 may maintain a copy of the management data in a secondary data storage 120 in case of malfunction in the primary data storage 120. As shown in FIG. 2, the data storage 120 may send information about the stored management data 203 to the management data service provider 106.

As shown in FIG. 2, the management data service provider 106 may send a registration request 204 to a service registry 104 to register as service provider. In one or more embodiments, the registration request 204 includes a unique identifier for the management data service provider 106. For example, the unique identifier may be an IP address that identifies the server device 102 containing the management data service provider 106 on a network. In one or more embodiments, the registration request 204 further includes identifying the service type the management data service provider 106 provides. For example, the registration request 204 may include information that the service the management data service provider 106 provides is management data service. In one or more embodiments, the registration request may include further details about the management data the management data service provider 106 provides, which will be further discussed in connection to FIG. 3.

A shown in FIG. 2, the service registry 104 may perform an act 206 of storing the management data service registration as a service provider in its registry. For example, the service registry 104 may register the unique identifier provided with the registration request 204, that identifies the management data service provider 106 as providing stored management data to authorized consumers. In one or more embodiments, the service registry 104 contains a list of registered service providers with their unique identifier (e.g., IP address). In one or more embodiments, the list may include additional information about the management data, as further discussed in connection to FIG. 3.

A shown in FIG. 2, the service registry 104 may send a registration acknowledgement 208 to the management data service provider 106 in response to receiving the registration request 204 and storing the management service registration 206. For example, the registration acknowledgement 208 may signify an acknowledgement or receipt of the registration request 204, or the registration acknowledgement 208 may acknowledge a successful registration of the management service based on the registration request 204.

As shown in FIG. 2, the consumer 108 may perform an act 210 of identifying need for management data. For example, the consumer 108 may require management data to train an AI/ML model with historical management data. In one or more embodiments, the consumer 108 may send a request for address 212 to the service registry 104 in order to find a management data service provider 106. In or more embodiments, the consumer 108 may send a request for address 212 to the service registry 104 in order to find a management data service provider 106 that provides a specified type of management data that the consumer 108 has requested. In one or more embodiments, the request for address 212 may include an indication that the consumer 108 is requesting stored management data. In one or more embodiments, the request for address 212 may further include additional requirements for the requested service as will be further discussed in connection to FIG. 3.

The service registry 104 may, in response to receiving the request for address 212, perform an act 214 of identifying the management data service provider 106 as a management data service provider. For example, the service registry 104 may search for a service provider from the registered service provider list the service registry 104 maintains based on the request for address 212. After the service registry 104 has identified a proper service provider, the service registry 104 may send a provide address 216 message to the consumer 108. The provide address 216 message may include the unique identifier, such as an IP address to the management data service provider 106 that may provide the requested data.

The consumer 108 may, in response to receiving the provide address 216 message send a request for management data 218 to the management data service provider 106 by using the unique identifier received from the service registry 104. In one or more embodiments, the request for management data 218 may include additional details of the type of management data the consumer 108 needs, as will be further discussed in connection to FIG. 3.

A shown in FIG. 2, the management data service provider 106 may perform an act 220 of searching for requested management data. For example, the management data service provider 106 may include a list of different types of management data accessible to the management data service provider 106 and search for a correct data type based on the request for management data 218. Once the management data service provider 106 locates the data storage 120 storing the requested management data, the management data service provider 106 may send a request data 222 to the data storage 120. In response, the data storage 120 will deliver data 224 to the management data service provider 106 that includes the requested data.

After the management data service provider 106 has received the requested management data from the storage, it may respond to the request 226 by providing the requested management data to the consumer 108. In one or more embodiments, the response to request 226 may include at least part of the management data requested.

As shown in FIG. 2, the consumer 108 may perform an act 228 of training AI/ML algorithm with the received management data. For example, the received management data may be historical management data on RAN performance and hence it may help the AI algorithm to better simulate a RAN performance on different environments.

The FIG. 2 example may provide a useful implementation for a deployment scenario where there are few management data service provider services deployed (e.g., fewer than a threshold number of known or discoverable management data service provider services). In this example, due to the fewer management data service provider services, the consumers directly inquiring about management data poses a limited processing overhead, thus enabling the consumers to quickly discover and retrieve management data without utilizing significant processing resources and monopolizing bandwidth, processing, storage, and other computing resources.

FIG. 3 is a signaling diagram 300 illustrating an example of a consumer self-discovering management data in telecommunication network having multiple data storages, in accordance with at least one or more embodiments. A shown in FIG. 3, a data storage A 120a and a data storage B 120b may perform an act 302A and an act 302B respectively, of storing a management data. For example, the management data may be written to the data storage A's 120a or data storage B's 120b storage media, such as hard drive, solid-state drive (SSD), USB flash drives, or optical discs. In one or more embodiments, the management data may have been produced by a management data producer. For example, a management data producer may be one or more of a core network function, a radio network function, or a network management function. In one or more embodiments, the management data may be received by the data storage A 120a and data storage B 120b from the management data producer, or from another data storage 120. For example, a primary data storage may maintain a copy of the management data in a secondary data storage in case of malfunction in the primary data storage.

In one or more embodiments, the data storage A 120a and the data storage B 120b may store same management data. In one or more embodiments, the data storage A 120a and the data storage B 120b may store two different management data or two different management data types. For example, data storage A 120a may store performance data, while data storage B 120b may store faults data. In one or more embodiments, the data storage A 120a and data storage B 120b may store management data from a different collection window. For example, the data storage A 120a may store management data that was collected between May 1^{st} and May 2^{nd} of 2023, and the data storage B 120b may store management data that was collected between May 1st and May 2nd of 2022.

In one or more embodiments, the data storage A 120a and the data storage B 120b may store management data in different format. For example, the data storage A 120a may store management data in text format, and the data storage B 120b may store management data in numeric format.

In one or more embodiments, the data storage A 120a and the data storage B 120b may store management data from different data producers. For example, the data storage A 120a may store management data produced by a core network function, and the data storage B 120b may store management data produced by a network management function.

In one or more embodiments, the data storage A 120a and the data storage B 120b may store management data produced at different instances. For example, the data storage A 120a may store management data produced by a first AMF and the data storage B 120b may store management data produced by a second AMF. In one or more embodiments, the data storage A 120a and the data storage B 120b may store management data produced at different geographical location. For example, the data storage A 120a may store management data that was produced at Seattle, WA, and the data storage B 120b may store management data produced at New York, NY.

In one or more embodiments, the management data stored in the management data service provider 106A and the management data service provider 106B may include one or more of the following differences; a management data type, a collection window, a format type, a data producer type, a data producer instance, and a geographical location.

As shown in FIG. 3, the data storage A 120a and data storage B 120b may send information about the stored management data, 303a and 303b respectively, to the management data service provider 106. As further shown, the management data service provider 106 may send a registration request 304 to a service registry 104 to register as service provider. The registration request 304 includes a unique identifier for the management data service provider 106. For example, the unique identifier may be an IP address that identifies the server device 102 containing the management data service provider 106 on a network. In one or more embodiments, the registration requests 304 further include identifying the service type the management data service provider 106 provide. For example, the registration request 304may include information that the service the management data service provider 106 provides is management data service.

In one or more embodiments, the registration requests 304 may include further details about the specific management data accessible to the management data service provider 106. For example, the registration request 304 may include one or more of the following information about the service it provides; a management data type, a collection window, a format type, a data producer type, a data producer instance, and a geographical location.

A shown in FIG. 3, the service registry 104 may perform act 306 of storing the management data service provider 106 as service provider in its registry. For example, the service registry 104 may register the unique identifier provided with the registration request 304, that identifies the management data service provider 106 as providing stored management data to authorized consumers. In one or more embodiments, the service registry 104 contains a list of registered service providers with their unique identifier (e.g., IP address). In one or more embodiments, the list may include additional information about the management data each service provider provides. For example, the list may include one or more of the following information; a management data type, a collection window, a format type, a data producer type, a data producer instance, and a geographical location.

A shown in FIG. 3, the service registry 104 may send a registration acknowledgement 308 to the management data service provider 106 in response to receiving registration requests 304 and storing the management service registration 306. For example, the registration acknowledgement 308 may signify an acknowledgement or receipt of the registration request 304, or the registration acknowledgement 308 may acknowledge a successful registration of the management service based on the registration request 304.

A shown in FIG. 3, the consumer 108 may perform an act 310 of identifying need for management data. For example, the consumer 108 may be a network entity hosting an AI/ML model that collects data over a period of time for training and/or AI implementation purposes. In one or more embodiments, the consumer 108 may send a request for address 312 to the service registry 104 in order to find a service provider that provides the type of management data that the consumer 108 needs. In one or more embodiments, the request for address 312 may include that the consumer 108 is requesting stored management data. In one or more embodiments, the request for address 312 may further include additional requirements for the requested management data. For example, the request for address 312 may include one or more of the following requirements for the management data; a management data type, a collection window, a format type, a data producer type, a data producer instance, and a geographical location.

The service registry 104 may, in response to receiving the request for address 312, perform an act 314 of identifying a management data service provider 106 as a management data service provider. In one or more embodiments, the service registry 104 may search for a service provider from the registered service provider list the service registry 104 maintains based on the request for address 312.

After the service registry 104 has identified a proper service provider, the service registry 104 may send a provide address 316 message to the consumer 108. The provide address 316 message may include the unique identifier, such as an IP address to the management data service provider 106 that may provide the requested service.

The consumer 108 may, in response to receiving the provide address 316 message send a request for management data 318 to the management data service provider 106 by using the unique identifier received from the service registry 104. In one or more embodiments, the request for management data 318 may include additional details of the type of management data the consumer 108 needs. For example, the request for management data 318 may include that the consumer 108 request faults data produced by network management function located in Seattle, WA.

A shown in FIG. 3, the management data service provider 106 may perform an act 320 of searching for requested management data. For example, the management data service provider 106 may have access to various different types of data and search for a correct data type based on the request for management data 318. For example, if the request management data 318 includes a requirement to have faults management data, the management data service provider 106 will identify that data storage A 120a includes faults management data. In another example, if the request for management data 318 includes a requirement to have management data produced by a network management function, the management data service provider 106 will identify that data storage B 120b includes management data produced by network management function. In yet another example, if the request for management data 318 includes a requirement to have faults data produced in Seattle, WA, the management data service provider 106 may identify that data storage A 120a includes faults data produced in Seattle, WA.

In one or more embodiments, once the management data service provider 106 locates the correct data storage, here the data storage 120a, storing the requested management data the management data service provider 106 may send a request data 322 to the data storage 120a. In response, the data storage 120a will send a deliver data 324 to the management data service provider 106 that includes the requested data.

After the management data service provider 106B has found the requested management data from the storage, it may respond by sending a response to request 326. For example, the response to request 326 may include at least part of the management data requested.

As shown in FIG. 3, the consumer 108 may perform an act 328 of training AI/ML algorithm with the received management data. For example, the received faults data produced in Seattle, WA may help the AI algorithm to better simulate a faults on different environments.

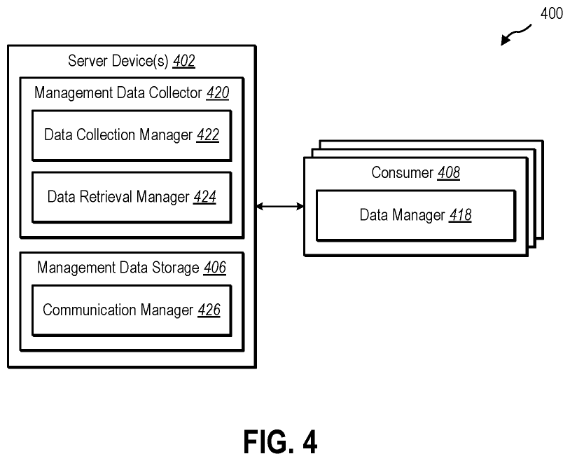

FIG. 4 illustrates an example environment 400 showing systems and devices that may be implemented in a telecommunications network. As shown in FIG. 4, the environment 400 includes one or more server devices 402 and consumers 408 in communication with one another. In the example shown in FIG. 4, the environment 400 includes a management data collector 420 and a management data storage 406 implemented on one or more server devices 402. In one or more embodiments, the management data collector 420 and the management data storage 406 may be implemented on a same server device 402. In one or more embodiments, the management data collector 420 and the management data storage 406 may be implemented on two separate server devices 402. In one or more embodiments, one or both of the management data collector 420 and the management data storage 406 may be implemented within core network and/or cloud computing system of the telecommunication network. It will be noted that one or more implementations may include multiple management data storage 406 entities.

As shown in FIG. 4, management data collector 420 may include a data collector manager 422. A data collector manager 422 may be configured to facilitate collection of management data from any number of management data producers (not shown). As many different consumers 408 can request network functions (NF) or network management functions to produce management data the data collector manager 422 is configured to coordinate management data requests to optimize management data production and delivery. In one or more embodiments, the data collector manager 422 coordinates the management data collection. Coordinating management data collection may include various functionalities such as determining if the requested management data is stored on a management data storage 406, determining if the requested management data is already being collected, determining if a request to collect the data should be sent to the management data producer, selecting the optimum path to deliver the management data, providing configuration instructions to a data bus on how to format and process the outgoing management data sent to the consumer, and preventing any overlap in collecting management data.

The data collector manager 422 may be configured to receive a request from a consumer 408 and to respond to the request. For example, the request may be a request for a management data and the data collector manager 422 may be configured to send at least part of the requested management data in response to the request. For example, the request may identify that the consumers 408 is searching for a stored management data from a particular management data producer (e.g., a RAN function), or the request may identify other specific requirements for the management data as further discussed below.

In one or more embodiments, the data collector manager 422 may be configured to coordinate collection of both real time management data and stored management data. In real time management data collection, the data collector manager 422 coordinates the collection of management data directly from a management data producer. The collection of real time management data from data producers is further discussed in patent application titled “Collecting and Managing Access to Management Data in a Telecommunications Network” (application Ser. No. 18/297,358), filed on Apr. 7, 2023. In one or more embodiments, if the data collector manager 422 determines that the request for management data is already collected and stored, a data retrieval manager 424 may be configured to search for a correct management data storage 406 where the requested management data is stored. The data retrieval manager 424 may manage a list of one of more management data storage(s) 406 that store management data including a unique identifier (e.g., an IP address) for each management data storage 406. In one or more embodiments, the data retrieval manager 424 may further include additional details of the management data stored at each management data storage 406. For example, the list may include one or more of the following; a management data type, a collection window, a format type, a data producer type, a data producer instance, and a geographical location.

The management data storage 406 may be implemented as a single entity (e.g., a single storage) or it may be implemented as a distributed storage system that includes multiple storage spaces in multiple entities (storages) with multiple different unique identifiers (e.g., IP addresses). As shown in FIG. 4, the management data storage 406 may optionally include a communication manager 426. The communication manager 426 may receive a service requests from the data retrieval manager 424 that identify the type of management data the consumers 408 needs. For example, a consumer 408 may request performance management data produced between May 1st and May 31st, 2023 during rush-hour. The communication manager 426 may then locate and deliver the requested management data to data retrieval manager 424 in response to the request and the data collector manager 422 may forward the management data to the consumer 408. In one or more embodiments, if the requested management data is not stored at the management data storage 406, or the communication manager 426 is otherwise unable to locate the requested management data, the communication manager 426 may respond with data not found message or with unexpected failure message.

As shown in FIG. 4, the environment 400 includes any number of consumer entities 408. The consumers 408 may refer to any entity requesting access to the stored management data collected from the various sources and maintained on a management data storage 406. In one or more embodiments described herein, the consumer entities 408 refer to network functions on a cloud computing system (e.g., a core network of the cloud computing system) requesting access the stored management data. For example, a consumer 408 may be a management data analytics function (MDAF) that provides management data analytics services for one or more network functions, network slice subnet instances, and/or network slice instances. In this example, the consumer (e.g., the MDAF) may run different analytics on the stored management data as defined in 3GPP TS 28.533. In another example, a consumer may refer to a network data analytics function (NWDAF) that runs analytics on stored management data as defined in 3GPP TS 23.288.

The environment 400 shown in FIG. 4 may provide a useful implementation in networks having multiple data storage devices having management data stored thereon. In this example, the management data collector 420 maintains a record of all management data requests and management data storages where stored management data is stored allowing the consumer to interact only with one network entity (e.g., the management data collector 420), to efficiently discover and retrieve any management data.

FIG. 5 is a signaling diagram 500 illustrating an example of a proxied-discovery of management data in telecommunication network, in accordance with at least one or more embodiments. A shown in FIG. 5, a consumer 408 may perform an act 550 of identifying need for management data. For example, the consumer 408 may be a network element hosting an AI/ML model that collects data over a period of time for training and/or AI implementation purposes. In one or more embodiments, the consumer 408 may send a request for management data 552 to the management data collector 420. In one or more embodiments, the request for management data 552 may include additional details regarding the management data the consumer 408 requires. In one or more embodiments, the request management data 552 may further include one or more of, a management data type, a collection window, a format type, a data producer type, a data producer instance, and a geographical location.

As shown in FIG. 5, the management data collector 420 may further perform an act 554 of determining a collection status for the requested management data. In one or more implementations, this includes identifying at least a portion of the management data that has already been collected and stored (e.g., on the management data storage 406). In one or more embodiments, the act 554 includes identifying that the requested management data is already collected and stored. For example, if another consumer has previously requested the same management data from the management data collector 420, the management data collector 420 will have a record of it. Furthermore, the act 554 may further include the act of identifying the management data storage 406 storing the requested management data. For example, the management data collector 420 will have a record of the prior collection of the requested data together with the management data storage location in which it is stored at.

The management data collector 420 may then request for the management data 556 from the identified management data storage 406. The request for the management data 556 may include additional details of the type of management data requested, such as a management data type, a collection window, a format type, a data producer type, a data producer instance, a geographical location, or a combination of one or more of these.

As shown in FIG. 5, the management data storage 406 may then perform an act 558 of searching for the requested management data. For example, in case the management data storage 406 stores multiple different management data, the management data storage 406 may search its database for the specified management data requested. In response to finding the requested management data, the management data storage 406 may send a response to the request 560 message to the management data collector 420. For example, the response to the request 560 may include the management data requested.

As shown in FIG. 5, the management data collector 420 may then perform an act 562 of confirming the consumer as the recipient of the management data. For example, the management data collector 420 keeps a record of all incoming and outgoing requests for management data and may identify the correct consumer 408 based on the specific management data received from the management data storage 406. The management data collector 420 may then provide a response to the request 564. For example, the management data collector 420 may forward the received management data to the consumer 408.

While not shown in FIG. 5, the consumer 408 may perform one or more additional acts related to training AI/ML algorithms with the received management data. For example, the received management data may be historical management data on RAN performance. In one or more implementations, the management data may be used to train or refine an AI algorithm to better simulate a RAN performance in different environments. Training or revising an AI/ML algorithm may be performed in a similar manner as discussed above in connection with other examples described above.

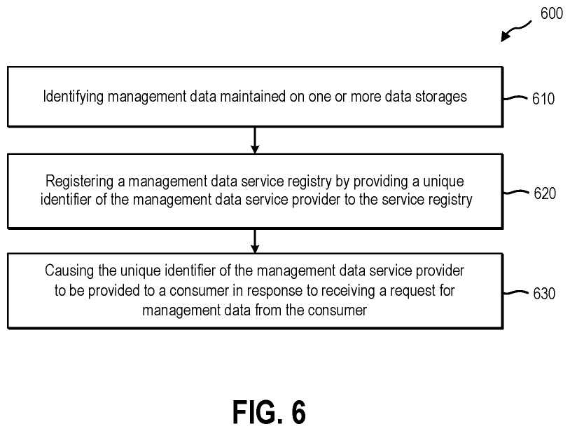

Turning now to FIG. 6, this figure illustrates an example flowchart including a series of acts for retrieving and coordinating access to management data stored in a core network of a telecommunications environment. It will be appreciated that acts described herein may be performed in different orders and may include some or all of the acts described in connection with different examples. The acts described herein may be performed as part of a method. In one or more embodiments, a non-transitory computer-readable medium can include instructions thereon that, when executed by one or more processors, cause a server device and/or client device to perform the acts described herein. In one or more embodiments, a system can perform the acts described herein.

FIG. 6 illustrates a series of acts 600 for coordinating retrieving and coordinating access to management data stored in a core network of a telecommunications environment. As shown in FIG. 6, the series of acts 600 includes an act 610 of identifying management data maintained on one or more data storages. For example, the act 610 may include identifying, by a management data service provider management data being associated with management of one or more operations on the telecommunication network. In one or more embodiments, the management data may be received from a management data producer. For example, the management data may be received from a core network function, a radio network function, or from a network management function.

The series of acts 600 additionally includes an act 620 of registering a management data service registry where registering includes providing a unique identifier of the management data service provider to the service registry. In one or more embodiments, the act 620 includes registering, by the management data service provider, a management data service with the service registry, wherein registering the management data service with the service registry includes providing unique identifier of the management data service provider to the service registry. In one or more embodiments, the unique identifier is an IP address. In one or more embodiments, when registering the management data service with the service registry, the management data service provider may additionally provide one or more of a management data type, a collection window, a format type, a data producer type, a data production instance, and a geographical location. For example, the management data type may be a performance management data, performance indicators data, faults data or traces data. In one or more embodiments, the service registry is a network entity implemented in a core network of a fifth generation (5G) cellular communication network.

The series of acts 600 additionally includes an act 630 of causing the unique identifier of the management data service provider to be provided to a consumer in response to receiving a request for management data from the consumer. In one or more embodiments, the act 630 includes causing the unique identifier of the management data service provider to be provided to a consumer in response to receiving a request for management data from the consumer where providing the unique identifier of the management data service provider to the consumer facilitates delivery of at least a portion of the management data to the consumer. The request for management data may indicate one or more requirements regarding a management data type, a collection window, a format type, a data producer type, a data production instance, and a geographical location. In one or more embodiments, the service registry will identify one or more management data service providers that include at least part of the requested management data.

The series of acts 600 further includes an act of causing at least part of the requested management data to be delivered to the consumer. In one or more embodiments, the management data to be delivered to the consumer includes management data retrievable from a first storage space of the management data service provider associated with the management data service provider unique identifier or management data from a second storage space of the management data service provider associated with the second management data service provider unique identifier.

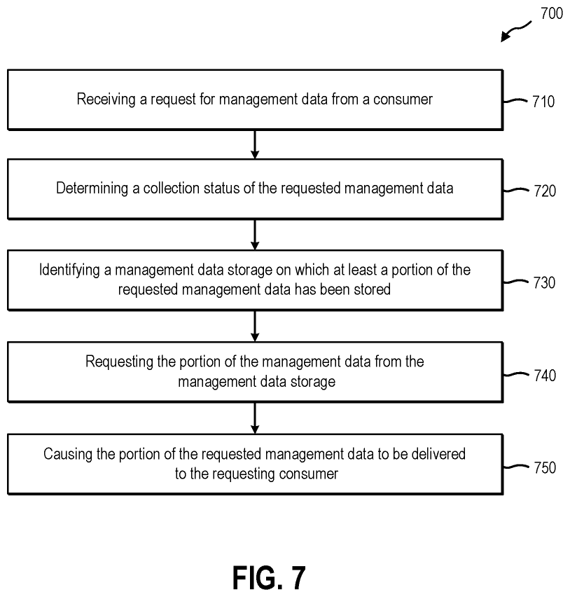

Turning now to FIG. 7, this figure illustrates an example flowchart including a series of acts for retrieving and coordinating access to management data stored in a cloud computing environment hosting a 5G telecommunication network. It will be appreciated that acts described herein may be performed in different orders and may include some or all of the acts described in connection with different examples. The acts described herein may be performed as part of a method. In one or more embodiments, a non-transitory computer-readable medium can include instructions thereon that, when executed by one or more processors, cause a server device and/or client device to perform the acts described herein. In one or more embodiments, a system can perform the acts described herein.

FIG. 7 illustrates a series of acts 700 for retrieving and coordinating access to management data stored in a 5G telecommunication network, in accordance with at least one or more embodiments. In one or more embodiments, a cloud computing environment may be hosting the 5G telecommunication network. As shown in FIG. 7, the series of acts 700 includes an act 710 of receiving a request for a management data from a consumer, the management data being associated with management of one or more operations on the telecommunication network. In one or more embodiments, the request for management data may include additional requirements on the characteristics of the requested management data. For example, the request for management data may indicate one or more requirements regarding a management data type, a collection window, a format type, a data producer type, a data production instance, and a geographical location. In one or more embodiments, where the requested management data includes a requirement for the management data type, the management data type may be a performance management data, a performance indicators data, a faults data or a traces data. In one or more embodiments, where the request for management data further includes a requirement for a data producer type, the management data type may be one or more of a core network function, a radio network, function, and a network management function.

The series of acts 700 additionally includes an act 720 of determining that the requested management data has already been collected and stored. In one or more embodiments, the series of acts 700 may be implemented by a network entity in a core network of a fifth generation (5G) cellular communication network. In one or more embodiments, the network entity is configured to coordinate management data requests and the collection of both real time management data and stored management data. For example, the network entity may be a management data collector.

The series of acts 700 additionally includes an act 730 of identifying a management data service provider storing at least part of the requested management data. In one or more embodiments, the management data service provider may be implemented on a same server device as the network entity performing the series of acts 700. In one or more embodiments, the management data service provider may be implemented on a separate server device as the network entity performing the series of acts 700. In yet another embodiment, the network entity may identify one or more management data service providers storing at least part of the requested management data.

The series of acts 700 further includes an act 740 of requesting from the identified management data service provider at least part of the requested management data. In one or more embodiments, two or more identified management data service providers may be requested for at least part of the requested management data.

The series of acts 700 additionally includes an act 750 of causing at least part of the requested management data to be delivered to the consumer. In one or more embodiments, causing at least part of the requested management data to be delivered to the consumer further includes receiving the at least part of the requested management data from the management data service provider and forwarding the at least of the requested management data to the consumer. In one or more embodiments, causing at least part of the requested management data to be delivered to the consumer further includes the management data service provider providing an access for the consumer to directly access the at least part of the requested management data stored at the management data service provider.

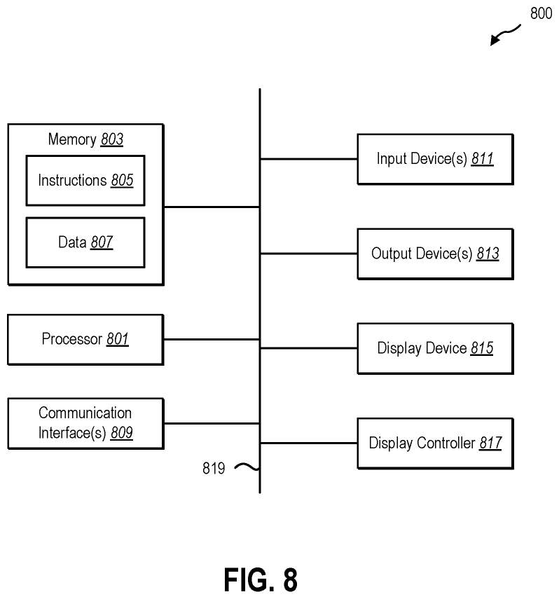

FIG. 8 illustrates certain components that may be included within a computer system 800. One or more computer systems 800 may be used to implement the various devices, components, and systems described herein.

The computer system 800 includes a processor 801. The processor 801 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for retrieving and coordinating access to management data stored in a core network of a telecommunications environment, the method being performed by a computing device having a management data service provider entity implemented thereon, the method comprising:
identifying, by the management data service provider, management data maintained on one or more data storages, the management data being associated with management of one or more operations on the telecommunications network;
registering, by the management data service provider, a management data service with a service registry, wherein registering the management data service with the service registry includes providing a unique identifier of the management data service provider to the service registry; and
causing the unique identifier of the management data service provider to be provided to a consumer in response to receiving a request for management data from the consumer, and wherein providing the unique identifier of the management data service provider to the consumer facilitates delivery of at least a portion of the management data to the consumer.

2. The method of claim 1, wherein the unique identifier is an IP address.

3. The method of claim 1, wherein registering the management data service with a service registry further includes registering one or more of a management data type, a collection window, a format type, a data producer type, a data production instance, and a geographical location where the management data was collected.

4. The method of claim 3, wherein registering the management data service includes registering the management data type, and wherein the management data type is one or more of performance management data, performance indicators data, faults data, and traces data.

5. The method of claim 3, further comprising receiving the request for the management data from the consumer, wherein receiving the request for the management data from the consumer includes receiving one or more of an identification of a management data type, a collection window, a format type, a data producer type, a data production instance, or a geographical location.

6. The method of claim 1, wherein the request includes the unique identifier and a second unique identifier associated with a second management data service provider, wherein a first portion of the management data is retrieved at a first data storage by the management data service provider based at least in part on the request including the unique identifier, and wherein the management data is retrieved at a second data storage by the second management data service provider based at least in part on the request including the second unique identifier.

7. The method of claim 1, wherein the service registry is a network entity implemented in a core network of a fifth generation (5G) cellular communication network.

8. The method of claim 1, wherein facilitating delivery of at least a portion of the management data to the consumer includes providing access to management data maintained or stored by a management data producer.

9. The method of claim 8, wherein the management data producer is at least one of a core network function, a radio network function, or a network management function that generates the management data.

10. A method for retrieving and coordinating access to management data stored in a fifth generation (5G) telecommunication network, the method comprising:
receiving, from a consumer, a request for management data, the management data being associated with management of one or more operations on the telecommunications network;
determining a collection status of the requested management data indicating that the requested management data has previously been collected and stored;
identifying a management data storage on which a portion of the requested management data has been stored;
requesting, from the management data storage, the portion of the requested management data; and
causing the portion of the requested management data to be delivered to the consumer.

11. The method of claim 10, wherein the request for the management data from the consumer includes an identification of one or more of a management data type, a collection window, a format type, a data producer type, a data production instance, or a geographical location.

12. The method of claim 11, wherein the request for the management data from the consumer includes receiving the management data type, and wherein the management data type is one or more of performance management data, performance indicators data, faults data, or traces data.

13. The method of claim 10, wherein the request for the management data from the consumer includes an identification of a data producer type, wherein the data producer type is one or more of a core network function, a radio network function, or a network management function.

14. The method of claim 10, wherein the method is implemented by a network entity in a core network of a 5G cellular communication network.

15. The method of claim 14, wherein the network entity is configured to coordinate management data requests and collection of both real-time management data and previously stored management data.

16. A system, comprising:
at least one processor;
memory in electronic communication with the at least one processor; and
instructions stored in the memory, the instructions being executable by the at least one processor to:
identify, by a management data service provider, management data maintained on one or more data storages, the management data being associated with management of one or more operations on a telecommunications network;
register, by the management data service provider, a management data service with a service registry, wherein registering the management data service with the service registry includes providing a unique identifier of the management data service provider to the service registry; and
provide the unique identifier of the management data service provider to the service registry, wherein the service registry is configured to provide the unique identifier of the management data service provider to a consumer in response to receiving a request for management data from the consumer, and wherein providing the unique identifier of the management data service provider to the consumer facilitates delivery of at least a portion of the management data to the consumer.

17. The system of claim 16, wherein registering the management data service with a service registry further includes registering one or more of a management data type, a collection window, a format type, a data producer type, a data production instance, and a geographical location where the management data was collected.

18. The system of claim 16, wherein registering management data service includes registering a management data type, and wherein the management data type is one or more of performance management data, performance indicators data, faults data, and traces data.

19. The system of claim 16, wherein facilitating delivery of at least a portion of the management data to the consumer includes providing access to management data maintained or stored by a management data producer.

20. The system of claim 19, wherein the management data producer is at least one of a core network function, a radio network function, or a network management function that generates the management data.
